(19) United States
(12) Patent Application Publication
(10) Pub. No.: US 2003/0198438 A1
(43) Pub. Date: Oct. 23, 2003

(54) Tunable add/drop multiplexer

(76) Inventors: Everett X. Wang, San Jose, CA (US); Dmitri E. Nikonov, San Jose, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/126,309

(22) Filed: Apr. 19, 2002

(51) Int. Cl. G02B 6/26; G02B 6/34

(52) U.S. Cl. 385/39; 385/15; 385/37

(57) ABSTRACT

A tunable add/drop multiplexer may be formed with a pair of identical tunable surface gratings. In one embodiment, the tunable surface grating may be placed in each arm of a Mach-Zehnder interferometer. A heater may be applied to each surface grating to change the thermal-optic properties of the grating and to change the wavelength that is reflected by the grating. As a result, by changing the current through the heater, the wavelength that is dropped by the Mach-Zehnder interferometer may be varied.

### BACKGROUND

This invention relates to optical networks and, particularly, to add/drop multiplexers.

An add/drop multiplexer is an important component in most optical networks. The multiplexer pulls down the desired channels from a network branch and replaces those channels with different contents. At the same time, the multiplexer lets the other channels pass through without significant insertion loss.

Generally, the add/drop multiplexer uses a fiber Bragg grating. The fiber Bragg grating drops input light at the Bragg wavelength. The characteristics of a fiber Bragg grating and, particularly, its Bragg wavelength, are fixed. In other words, a particular fiber Bragg grating is written, for example, using an ultraviolet light, to have a predetermined Bragg wavelength. As a result, a given grating may only be able to reject or drop one wavelength.

At different times, however, it may be desirable to have a grating that rejects different wavelengths. Thus, there is a need for a tunable add/drop multiplexer.

### BRIEF DESCRIPTION OF THE DRAWINGS

FIG. 1 is a schematic depiction of one embodiment of the present invention;

FIG. 2 is a cross-sectional view taken generally along the line 2-2 in FIG. 3 in accordance with one embodiment of the present invention; and

FIG. 3 is a top plan view of the embodiment shown in FIG. 2 in accordance with one embodiment of the present invention, exaggerated to show the sinusoidal edge profile.

### DETAILED DESCRIPTION

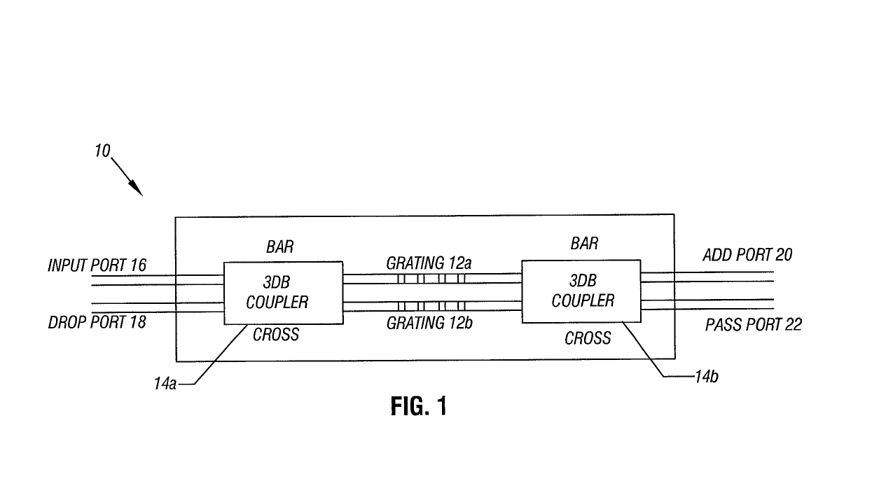

Referring to FIG. 1, an add/drop multiplexer (ADM) 10 includes a pair of gratings (FBG) 12a and 12b in one embodiment of the present invention. The ADM 10 also includes a pair of three deciBel (dB) couplers (or, in other words, 50/50 percent couplers) 14a and 14b. The input coupler 14a is coupled to an input port 16 that receives light of one or more wavelengths. The coupler 14a is also coupled to output or drop wavelength port 18 where light of a wavelength that is going to be dropped exits from the ADM 10. A second coupler 14b is coupled to a port 20 to add light of a particular wavelength and a port 22 to output light of a passed wavelength. Each coupler 14 includes a bar side and a cross side as indicated in FIG. 1.

The structure shown in FIG. 1 may be termed a Mach-Zehnder interferometer configured to form an add/drop multiplexer 10. Each identical surface grating 12 constitutes one of two arms of the Mach-Zehnder interferometer in accordance with one embodiment of the present invention. Input lights that match Bragg condition of the gratings propagate backward along the Mach-Zehnder arms and interfere with each other in the first coupler 14a. Once the optical path of both reflected lights are balanced, all the lights over the wavelength span of interest are phase matched and all optical energy is transferred into the cross path of the first coupler 14a with little energy returning back to the bar path.

The cross path of the first coupler 14a becomes the drop wavelength port 18 at which signals at the Bragg wavelength of the gratings 12 get filtered out from other channels. Signals at wavelengths other than the Bragg wavelength transmit through the gratings 12 and merge in the second coupler 14b.

All transmitted lights over the wavelength span of interest are phase matched using a balanced Mach-Zehnder interferometer. All energy is carried into the cross path of the second coupler 14b with little leakage to the bar path. As a result, the cross path of the coupler 14b becomes the pass wavelength port 22 through which signals outside the Bragg reflection band are transmitted.

The bar path of the second coupler 14b may be used as the add port 20 into which signals that carry the Bragg wavelength are launched. These added signals are reflected by the gratings 12, carried through the cross path of the second coupler 14b and join the pass signals at the pass wavelength port 22 without interfering with each other.

By adding identical gratings 12 to each of the arms of the interferometer, it is possible to make an optical add/drop multiplexer 10. In this add/drop multiplexer 10, the signal coming through the input arm is split at the first coupler 14a. When the signal wavelength is Bragg matched to gratings 12, the light is retroreflected by both gratings 12. The reflected light interferes at the first coupler 14a. When the reflected light is in phase, all the light exits the drop wavelength port 18.

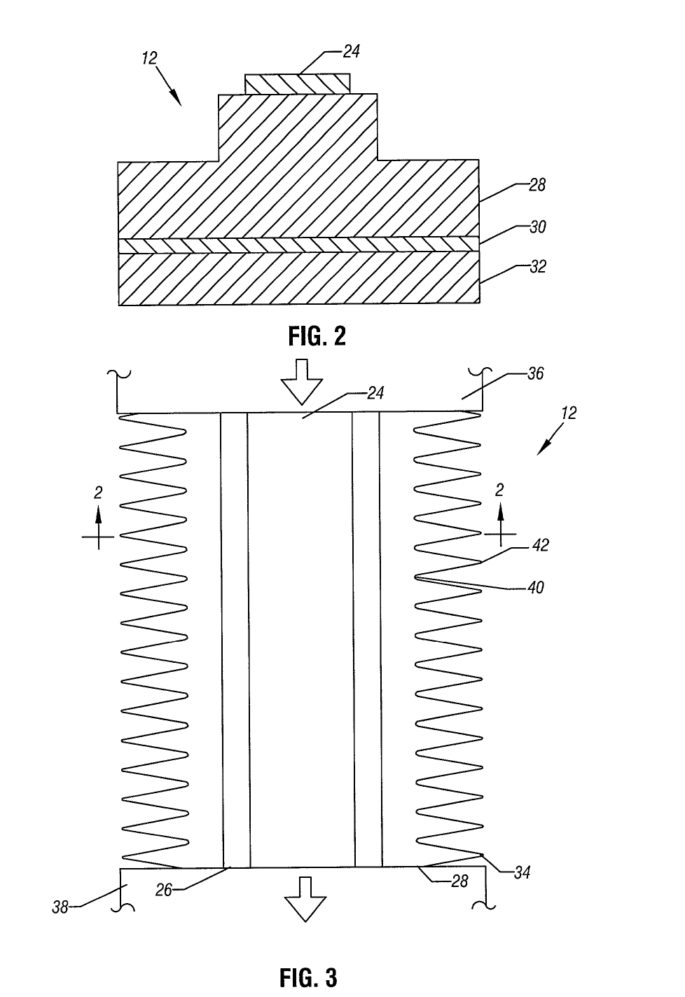

Referring to FIG. 2, each grating 12 includes a thin film heater 24 over a silicon-on-insulator (SOI) ridge waveguide 28 in one embodiment of the present invention. The ridge waveguide 28 may be covered with an upper cladding in some embodiments; however, the embodiment shown in FIG. 2 is air clad. The lower cladding 30 may be any of a variety of cladding materials, including silicon dioxide. A relatively high thermooptic coefficient substrate 32 may underlie the lower cladding 30.

Referring to FIG. 3, the ridge waveguide 28 may include a plurality of sinusoidal corrugations having protrusions 42 bounded by valleys 40. As a result, a refractive index is modulated by changing the width in the light propagation direction, indicated by the arrows L in FIG. 3. In other words, the light moves through the ridge waveguide 28 in the direction of the arrows L and encounters the changing width, modulating the refractive index.

However, in other embodiments, non-ridge or square waveguides may be utilized, and, in fact, in some embodiments, any waveguide may be utilized that is made of a material with a relatively high thermooptic coefficient, for example, exceeding 1×e-04 per degree Kelvin. Examples of suitable materials include silicon, polymer, indium phosphide, indium gallium arsenide, and gallium arsenide. By using a material with a high thermooptic coefficient, a highly tunable waveguide 28 may be provided.

By heating the waveguide 28 using the thin film resistance heater 24, its Bragg wavelength may be varied. In some embodiments, the thin film heater 24 may be a titanium tungsten or chrome thin film in order to give greater temperature control. The heater 24 may be deposited on said waveguide 28 so that it is in direct contact with the waveguide 28 or its upper cladding to vary its core temperature.

By simply changing the current through the heater 24, the refractive index of the waveguide 28 may be varied, causing the Bragg wavelength or the wavelength that is rejected by the add/drop multiplexer 10 to change. Since gratings are placed in both arms of the Mach-Zehnder interferometer, the Bragg wavelength of both gratings 12 may be changed by precisely controlled heating both gratings 12. One may then select a wavelength channel to drop and a wavelength channel to add in its place. The rest of the wavelengths may be passed with relatively low loss.

In accordance with some embodiments, making the add/drop multiplexer 10 in an integrated circuit provides far better control of device parameters and may also provide better control of the electrical heaters 24 that have the potential for much lower cost of manufacturing. For example, by using traditional semiconductor processes, such as silicon-on-insulator technology, by eliminating complicated processes of writing ultraviolet waves onto Bragg gratings, and by eliminating manual splicing of fibers, costs may be reduced in some embodiments.

In some embodiments, multiple devices may be placed in series to provide a series of tunable wavelengths. In a dense wavelength division multiplexing (DWDM) system, optical fiber carriers with tens or even hundreds of channels with different wavelengths enter the input port 16 of the device. A 3 dB coupler 14a separates the optical signal into two equal paths, with most of the wavelengths passing through the surface gratings 12 without any noticeable scattering and combining into the pass port 22 through the second 3 dB coupler 14b, except for the channel with the wavelength of the Bragg gratings. That channel is reflected back and out through the drop port 18. A signal with the same wavelength can then be added from the add port 20. The optical signal may be split into two and reflected from the gratings 12. Then the split signals merge into the same output with other channels.

Using a silicon-on-insulator ridge waveguide 28 as the surface grating 12, the period change of effective refraction is produced by the sinusoidal boundary of the ridge. An electron beam patterning and a reactive ion etching process may be utilized to make the ridge waveguide.

The reflected wavelength from the grating 12 is proportional to the effective index of the grating 12. This provides a method to tune the wavelength of a grating 12 using the thermal-optic effect. Due to the large thermal-optical coefficient of silicon, for example, the tunable wavelength can cover a large spectrum range. The temperatures of the gratings 12 are regulated by the thin film heaters 24 that may be directly deposited on each grating 12 in one embodiment.

The periodic geometry perturbation of the ridge waveguide 28 creates a periodic effective refraction perturbation along the light path. As a result, light whose wavelength matches a Bragg condition is reflected while allowing the rest of the light to pass.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An add/drop multiplexer comprising:
a Mach-Zehnder interferometer including a pair of arms; and
each of said arms including an identical grating in a waveguide formed of a material having a thermooptic coefficient greater than 1×e-04 per Kelvin.

2. The multiplexer of claim 1 wherein the said grating is formed by an essentially periodic change of the cross-section along the length the said waveguide.

3. The multiplexer of claim 1 wherein the change of width of said waveguides is produced by lithographic patterning and etching.

4. The multiplexer of claim 1 wherein said waveguide is substantially silicon.

5. The multiplexer of claim 1 wherein said surface grating is a ridge waveguide.

6. The multiplexer of claim 1 wherein said multiplexer is tunable.

7. The multiplexer of claim 6 including an electrical heater on each grating to controllably heat the grating and to change its Bragg wavelength.

8. The multiplexer of claim 7 wherein said heater is a thin film heater.

9. The multiplexer of claim 8 wherein said heater is a titanium tungsten thin film heater.

10. The multiplexer of claim 7 wherein said heater is a chrome heater.

11. The multiplexer of claim 5 wherein said ridge waveguide includes a series of protrusions extending along the waveguide transversely to the light propagation direction of said waveguide.

12. An add/drop multiplexer comprising:
a Mach-Zehnder interferometer including a pair of arms;
each of said arms including a surface grating including a waveguide; and
a heater formed on said waveguide to vary the temperature of said waveguide.

13. The multiplexer of claim 12 wherein said waveguide is substantially silicon.

14. The multiplexer of claim 12 wherein said surface grating is a ridge waveguide.

15. The multiplexer of claim 12 wherein said multiplexer is tunable to drop different wavelengths by varying the current through said heater.

16. The multiplexer of claim 15 wherein said heater is a titanium tungsten thin film heater.

17. The multiplexer of claim 16 wherein said heater is a chrome heater.

18. The multiplexer of claim 14 wherein said ridge waveguide includes a series of protrusions extending along the waveguide transversely to the light propagation direction of said waveguide.

19. The multiplexer of claim 12 wherein said heater is directly bonded to said waveguide.

20. The multiplexer of claim 14 wherein said waveguide is a silicon-on-insulator waveguide.

21. The multiplexer of claim 13 wherein the wavelength that is dropped by said multiplexer is selectable by varying the current through said heater.

22. A method comprising:
enabling light to pass through an add/drop multiplexer including a pair of gratings; and
varying the temperatures of said gratings to select the wavelength that is dropped by said add/drop multiplexer.

23. The method of claim 22 including forming the grating of a material having a themo-optic coefficient greater than 1×e-04.

24. The method of claim 22 including forming said grating with a waveguide that is substantially made of silicon.

25. The method of claim 22 including forming said waveguide as a ridge waveguide.

26. The method of claim 22 including providing an electrical heater on said gratings to controllably heat the grating to change its Bragg wavelength.

27. The method of claim 22 including forming a thin film heater on each of said gratings.

28. The method of claim 22 including bonding a heater directly to each of said gratings.

29. The method of claim 22 including providing a ridge waveguide in said surface grating and forming said waveguide as a silicon-on-insulator waveguide.
